(19) United States
(12) Patent Application Publication
(10) Pub. No.: US 2005/0111589 A1
(43) Pub. Date: May 26, 2005

(54) Method and circuit for sensing the transition density of a signal and variable gain phase detecting method and device

(75) Inventors: Francesco Centurelli, Roma (IT); Massimo Pozzoni, Pavia (IT); Giuseppe Scotti, Latina (IT); Alessandro Trifiletti, Velletri (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 10/837,508

(22) Filed: Apr. 30, 2004

(30) Foreign Application Priority Data
Apr. 30, 2003 (EP) 03425273.4

(51) Int. Cl. H04L 27/14

(52) U.S. Cl. 375/325

(57) ABSTRACT

A linear phase detector has a variable gain that is regulated as a function of the monitored transition density of the input signal. The transition density is sensed by a circuit that generates a signal corresponding to a time averaged common mode component of the differential signal output by an output stage of the phase detector.

### FIELD OF THE INVENTION

The present invention relates in general to linear phase detectors generating a differential signal representing a phase difference between two input signals.

### BACKGROUND OF THE INVENTION

In long distance transmission systems operating at high bit rates over standard signal fiber lines, data receivers may receive significantly distorted signals. Inter-symbolic interference, finite bandwidth, fiber nonlinearity and other non-idealities increase the probability of erroneous recognition of a received bit. For these reasons, it is often necessary to place, along the transmission line, data regenerating channel systems that sample a received signal and retransmit it to either a successive data regenerating system or to the end receiver.

The incoming data at the receiver may be considered as a varying analog signal from which a synchronization or clock signal may be recovered. Recovering the clock in the form of a signal that generally oscillates between a higher level and a lower level signal from the incoming signal is essential for sampling it correctly to regenerate the digital data to be transmitted.

Of course, the clock signal could alternatively be transmitted together with the data stream, and the clock can be easily filtered at the receiver. In the majority of cases, the clock must be recovered from the data stream using a phase locked loop (PLL).

FIG. 1 shows a sample architecture of a system for data regeneration. It is substantially composed of a phase-locked loop, which includes a phase detector PD, a loop filter LP and a voltage controlled oscillator VCO. The loop recovers the clock signal CK and provides it to a D-type flip-flop that samples the input signal for outputting a regenerated data stream.

The phase detector PD is input with the digital signal DAT to be regenerated and retransmitted, and the recovered clock CK. The phase detector PD commonly includes a differential stage that outputs a differential signal OUT+, OUT− representing the phase difference between the digital signal DAT and the clock CK. This differential signal is produced by comparing the transition edges of the digital signal and the clock signal.

The loop filter LP is input with the differential signal OUT+, OUT− and generates a control voltage Vc for a voltage controlled oscillator VCO by low pass filtering the differential component of the differential signal OUT+, OUT−. If the control voltage Vc is not null, the VCO adjusts the frequency of the recovered clock CK until the control voltage becomes null.

If the digital signal DAT switches regularly, the phase detector is able to continuously compare the transition edges of the recovered clock CK and the signal DAT. Thus, the recovered clock has a good precision. Differently, when the digital signal is a non-return to zero (NRZ) signal, such as the one depicted in FIG. 2, there may not be transitions for a relatively long time. During these intervals the PLL loop is no longer able to adjust the frequency of the recovered clock.

Many types of phase detectors are available. It is worth mentioning that the classical phase and frequency detector (PFD), the bang-bang detector and the linear phase detector are frequently used.

The PFD detector, shown in FIG. 3, is most commonly used in PLL systems because of its capability of detecting both phase and frequency errors. It comprises two D-type flip-flops. The first flip-flop is clocked by the input signal and the second flip-flop is clocked by the recovered clock generated by the voltage controlled oscillator VCO of the phase-locked loop. When one of these signals undergoes a transition, the output of the respective flip-flop is set. The two flip-flops may be reset only when both are set.

In this mode the flip-flops generate two output pulses. The difference between the duration of these two pulses represents the phase error between the two input signals. The advantage of this detector is its capability of sensing both phase errors and frequency errors, and that its output is proportional to the phase mismatch. A second advantage is that when the two inputs are synchronized, the duration of the output pulses is null and there is no injection into the loop filter, and as a consequence, the litter is minimized. A disadvantage of this architecture is that it does not work when there is an absence of transitions in the input signal, and so it is not usable for regenerating data for a NRZ transmission system.

A possible approach to overcome this limitation is represented by the so-called bang-bang phase detector, the working principle of which is illustrated by the timing diagram of FIG. 4. If a data transition occurs before a clock transition, then this phase detector outputs a fixed-length positive pulse to the loop filter in cascade. In the opposite case, that is, when a data transition occurs after the clock transition, a negative fixed-length pulse value is generated.

The disadvantage of this phase detector is that its output is not proportional to the phase error between data and the clock, i.e., this phase detector has a non-linear transfer function. A system for regenerating data that employs a bang-bang phase detector may continuously oscillate between a phase lead and a phase lag. This increases the frequency jitter of the recovered clock.

Another family of phase detectors is represented by the linear phase detectors like the Hogge phase detectors, which generate a signal proportional to the phase difference of their input signals. Both linear and bang-bang phase detectors exploit a similar working principle, which is as follows. At the transition of the incoming data, a positive or negative current or voltage pulse is output toward the loop filter, depending on whether the data leads or lags the clock. The amplitude of the pulse may be constant (bang-bang phase detectors) or proportional (linear phase detectors) to the phase difference between the data and the clock, as disclosed in the article by Aaron et al., titled “Integrated Fiber-Optic Receivers”, Kluwer Academic Publishers. Unfortunately, it is very difficult to use them when the data rate is relatively high because they are based on the use of flip-flops, which require a certain time for generating a stable output.

Linear phase detectors based on the use of analog differential stages are intrinsically fast. The differential current signal OUT+, OUT− output by a linear phase detector PD to be fed to the low pass loop filter LP that outputs the control voltage Vc of the VCO has an amplitude that depends on the gain of the phase detector circuit PD.

The amount of charge that is injected in the low pass loop filter LP in presence of a phase difference between the generally oscillating input signal DAT and the recovered clock signal CK will be determined by the phase difference and by the gain of the phase detector. If the phase detector PD is to function at significantly different bit rates and/or with NRZ signals, it becomes difficult to optimize the gain at the design stage if the contemplated operating frequencies vary within a broad range.

### SUMMARY OF THE INVENTION

In view of the foregoing background, an object of the invention is to improve the performance of a phase-locked loop (PLL) loop.

This and other objects, advantages and features in accordance with the present invention are provided by a linear phase detector having a variable gain that is based on the transition density of the generally oscillating input signal.

A method and a corresponding sensing circuit for monitoring the density of transitions of a generally oscillating signal input to a phase detector are provided. The phase detector has a differential output stage that generates a differential current signal representative of the phase difference between the oscillating signal and a clock signal applied to a second input of the phase detector.

A signal representative of the density of transitions of the oscillating input signal is generated as a function of a time averaged common mode component of the differential current signal output by the phase detector. In other words, the linear phase detector of the invention is effectively auto-adaptive to a varying density of transitions of the input digital signal.

### BRIEF DESCRIPTION OF THE DRAWINGS

The different aspects and advantages of the invention will appear even more evident through a detailed description of an embodiment and by referring to the attached drawings, wherein:

FIG. 1 illustrates a typical system for regenerating digital data in accordance with the prior art;

FIG. 2 is a sample waveform of a non-return-to-zero (NRZ) digital signal in accordance with the prior art;

FIG. 3 depicts a phase and frequency detector (PFD) in accordance with the prior art;

FIG. 4 shows the signal waveforms of a bang-bang phase detector in accordance with the prior art; and

FIG. 5 depicts a preferred embodiment of the phase detector of the invention.

### DETAILED DESCRIPTION OF THE PREFERRED EMBODIMENTS

A sample embodiment of a variable gain linear phase detector of the invention is depicted in FIG. 5. The phase detector is composed of a first differential pair of transistors Q3, Q4 controlled by the clock CK and by its inverted replica CKN for outputting the differential current signal OUT+, OUT−, and a second differential pair of transistors Q1, Q2 controlled by the digital input signal DAT and by its inverted replica DATN. The two differential pairs of transistors Q1, Q2 and Q3, Q4 are biased by a common current generator Ipd. The current from the common current generator Ipd is regulated by a feedback loop to vary the gain of the differential output stage Q3, Q4, according to the invention.

The regulation loop is implemented by adding a third differential pair of transistors Q3′, Q4′ that may be identical or scaled replicas of the transistors Q3, Q4 of the first (output) differential pair. The third differential pair of transistors Q3′, Q4′ are similarly driven by CK and CKN, such that the currents flowing in the transistors Q3′ and Q4′ are equal or proportional to the currents flowing in the corresponding output transistors Q3, Q4 of the first differential pair.

Therefore, common mode currents will conduct through the scaled replica pair of transistors Q3′ and Q4′. The common mode currents will be scaled replicas of the common mode currents present in the output differential pair Q3, Q4 of the phase detector.

The output common mode current flowing in the differential pair Q3′, Q4′ is forced through a low pass filter R2, C2 for generating a voltage V2 representative of a scaled time average of the output common mode current of the phase detector. This is a measure of the density of transitions of the input digital signal DAT.

The voltage V2 is applied to a first input of an error amplifier G, the other input of which is applied a reference voltage V1. The reference voltage V1 may be obtained by forcing a reference current Iref through a resistor R1. The error amplifier G regulates the current Ipd generated by the common bias generator of all three differential pairs of transistors to make V2 equal V1, according to a feed back control mode.

In presence of intervals of time during which the input digital signal DAT ceases to switch, the voltage V2 on the low-pass filter R2, C2 decreases. This signals that the time average of the common mode current forced through the filter is diminishing. The high gain differential error amplifier G input with the voltages V1 and V2 will therefore regulate the current Ipd that biases all three differential pairs of transistors to make null the difference between V2 and V1.

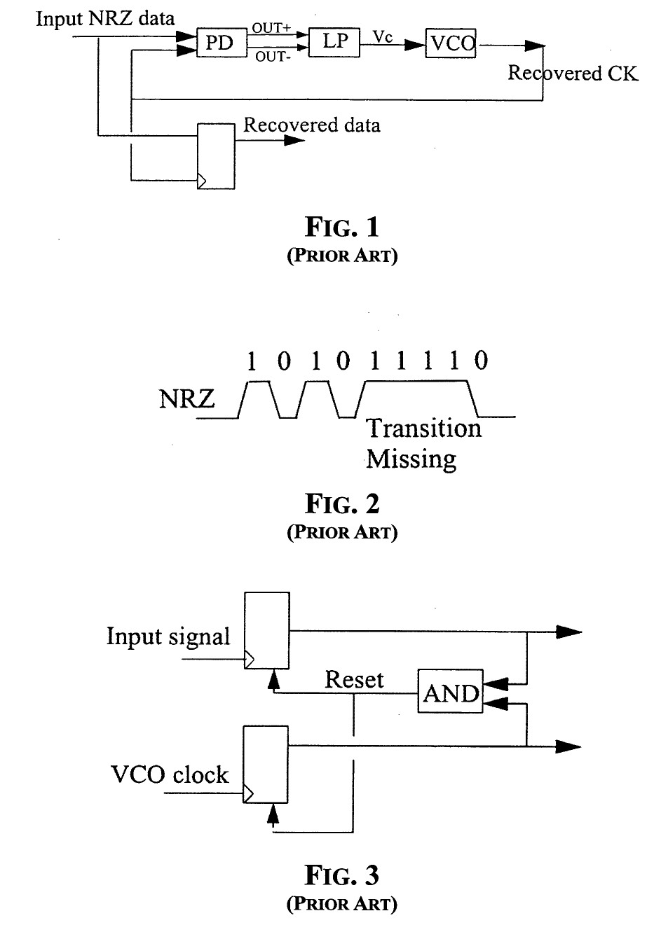

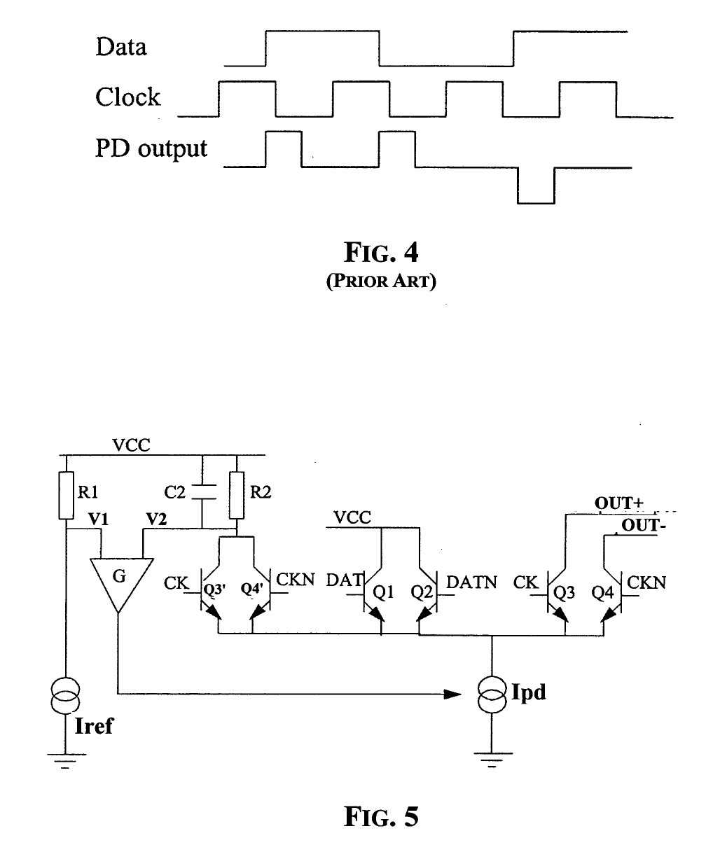

When transitions in the digital input signal DAT resume after a long sequence of substantially equal input values (e.g., in a NRZ signal), the transistors Q3 and Q4 of the first differential pair are biased with a relatively enhanced bias current and the gain of the differential stage will be at a correspondingly enhanced level. This will determine a correspondingly higher level of the control voltage Vc output by the low pass loop filter LP of the PLL (FIG. 1), causing a faster reaction of the PLL in recovering a possibly lost synchronization.

1-4. (canceled)

5. A method for monitoring transition density of an oscillating signal being input to a phase detector comprising a differential output stage that generates a differential output signal representing a phase difference between the oscillating signal and a clock signal also being input to the phase detector, the method comprising:
generating a representative signal corresponding to the transition density of the oscillating signal as a function of a time averaged common mode component of the differential output signal.

6. A method according to claim 5, wherein the differential output stage comprises a first differential pair of transistors and being respectively driven by the clock signal and by an inverted clock signal.

7. A method according to claim 5, wherein the monitoring is performed using a sensing circuit connected to differential output stage and comprising:
a second differential pair of transistors coupled to the differential output stage and being respectively driven by the clock signal and by an inverted clock signal; and
a filter coupled to the second differential pair of transistors at a common node defined therebetween, the filter receiving as input current to be conducted therethrough, and a voltage at the common node forms the representative signal.

8. A method for generating a differential output signal representing a phase difference between an oscillating signal and a clock signal applied to respective inputs of a phase detector comprising a differential output stage, the method comprising:
generating a representative signal corresponding to a transition density of the oscillating signal;
regulating a gain of the differential output stage for making the representative signal substantially equal to a reference voltage; and
generating the differential output signal at outputs of the differential output stage based upon its regulated gain.

9. A method according to claim 8, wherein the representative signal is generated as a function of a time averaged common mode component of the differential output signal.

10. A method according to claim 8, wherein the differential output stage comprises a first differential pair of transistors and being respectively driven by the clock signal and by an inverted clock signal; and wherein a current generator is connected to the first differential pair of transistors so that the regulated gain is based upon the current generator biasing the first differential pair of transistors.

11. A method according to claim 8, wherein generating the representative signal is performed using a sensing circuit connected to the differential output stage and comprising:
a second differential pair of transistors coupled to the differential output stage and being respectively driven by the clock signal and by an inverted clock signal; and
a filter coupled to the second differential pair of transistors at a common node defined therebetween, the filter receiving as input current to be conducted therethrough, and a voltage at the common node forms the representative signal.

12. A method according to claim 11, wherein an error amplifier is connected to the sensing circuit; and further comprising amplifying a difference between the representative signal and a reference voltage for regulating the gain of the differential output stage to make null the difference.

13. A circuit for monitoring transition density of an oscillating signal being input to a phase detector comprising a differential output stage that generates a differential output signal representing a phase difference between the oscillating signal and a clock signal also being input to the phase detector, the sensing circuit comprising:
a sensing circuit for generating a representative signal corresponding to the transition density of the oscillating signal.

14. A circuit according to claim 13, wherein the representative signal is generated as a function of a time averaged common mode component of the differential output signal.

15. A circuit according to claim 13, wherein said sensing circuit comprises:
a first differential pair of transistors coupled to the differential output stage and being respectively driven by the clock signal and by an inverted clock signal; and
a filter coupled to said first differential pair of transistors at a common node defined therebetween, said filter receiving as input current to be conducted therethrough, and a voltage at the common node forms the representative signal.

16. A circuit according to claim 13, wherein the differential output stage comprises a second differential pair of transistors and being respectively driven by the clock signal and by an inverted clock signal, and a bias current generator connected to the second differential pair of transistors; and wherein the bias current generator is regulated by a feedback loop including the sensing circuit.

17. A circuit according to claim 16, wherein the feedback loop further comprises a correction circuit connected to said sensing circuit and comprises an error amplifier for amplifying a difference between the representative signal and a reference voltage for regulating a gain of said differential output stage to make null the difference.

18. A phase detector comprising:
a differential output stage for generating a differential output signal representing a phase difference between an oscillating signal and a clock signal being input to the phase detector;
a bias current generator connected to said differential output stage; and
a feedback loop for regulating said bias current generator and comprising
a sensing circuit connected to said differential output stage for generating a representative signal corresponding to a transition density of the oscillating signal, and
a correction circuit connected to said sensing circuit and comprising an error amplifier for amplifying a difference between the representative signal and a reference voltage for regulating a gain of said differential output stage to make null the difference.

19. A phase detector according to claim 18, wherein the representative signal is generated as a function of a time averaged common mode component of the differential output signal.

20. A phase detector according to claim 18, wherein said sensing circuit comprises:
a first differential pair of transistors coupled to said differential output stage and being respectively driven by the clock signal and by an inverted clock signal; and
a filter coupled to said first differential pair of transistors at a common node defined therebetween, said filter receiving as input current to be conducted therethrough, and a voltage at the common node forms the representative signal.

21. A phase detector according to claim 18, wherein said differential output stage comprises a second differential pair of transistors and being respectively driven by the clock signal and by an inverted clock signal.

22. A phase detector according to claim 21, further comprising a third differential pair of transistors connected to said second differential pair of transistors and being respectively driven by the oscillating signal and by an inverted oscillating signal.
